(19) United States
(12) Patent Application Publication
(10) Pub. No.: US 2026/0117691 A1
(43) Pub. Date: Apr. 30, 2026

(54) Device for internal gripping of an exhaust pipe

(71) Applicant: Plymovent Group B.V., Alkmaar (NL)

(72) Inventors: Sebastiaan Wilhelmus Köhne, Uitgeest (NL); Ragheed Shamoon, Castricum (NL); Jasper Ebbinge, Haarlem (NL)

(73) Assignee: Plymovent Group B.V., Alkmaar (NL)

(21) Appl. No.: 18/570,653

(22) PCT Filed: Jun. 16, 2022
(86) PCT No.: PCT/NL2022/050337

§ 371 Date: Dec. 15, 2023

(30) Foreign Application Priority Data
Jun. 16, 2021 (NL) 2028465

(51) Int. Cl. F01N 13/18; B08B 15/00

(52) U.S. Cl. CPC F01N 13/18; B08B 15/002; F01N 2450/10

(57) ABSTRACT

Device (1) adapted for internal gripping of an exhaust pipe, comprising: a hand piece (20); a gripping device (100) comprising a pull element (120) and a plurality of substantially rigid segments (111-119) connected in series and moveable relative to each other, wherein one of said segments (111) is connected to the hand piece, and another of said segments (119) is connected to the pull element (120); wherein the plurality of segments is moveable between a substantially straight configuration, in which the segments are substantially aligned along an first axis (A), and a curved configuration, in which the segments are substantially aligned along a curve, wherein the pull element comprises a flexible portion (125) extending though the segments; wherein the hand piece (20) is provided with a manoeuvring device (40) adapted for pulling on the pull element (120) to cause the segments of the gripping device to move relative to each other to the curved configuration in which they form a curved shape for gripping an inner surface of the exhaust pipe and with the flexible portion of the pull element extending in non-linear fashion through the curved shape.

### FIELD OF THE INVENTION

The present invention relates to a device for internal gripping of an exhaust pipe, in particular to such a device which allows exhaust gas to pass there through when gripping the exhaust pipe. Such a device is typically used to draw off exhaust fumes from a vehicle exhaust while the vehicle's motor is running.

### BACKGROUND ART

US patent application US 2011/0101672 A1 describes a device for internal gripping of an exhaust pipe. This prior art device is provided with a gripping device which has a first and a second protrusion which are mutually connected to allow mutual displacement along a first axis, wherein such displacement imposes a mutual change of position of the first and second protrusions along a second axis which is perpendicular to the first axis. The device for internal gripping further comprises a manoeuvring device for achieving the mutual displacement of the two protrusions with an advancement unit which is arranged to displace the first protrusion along the first axis in relation to the manoeuvring device, and a connecting link, which connects the manoeuvring device to the second protrusion and which limits the displacement of said second protrusion along the first axis relative to the manoeuvring device during the displacement of the first protrusion by the advancement unit.

Though the known device may be connected to straight exhaust pipes in a convenient manner, it is difficult to connect to an exhaust which has a curve or bend near the distal end of the exhaust to which it is to be connected.

It is an object of the invention to provide a device for internal gripping of an exhaust pipe which may be more easily connected to a curved or bend end of an exhaust pipe. It is a further object of the invention to provide a gripping device that ensure a rapid and secure gripping of the device to the exhaust pipe.

### SUMMARY OF THE INVENTION

To this end, the present invention provides a device adapted for internal gripping of an exhaust pipe, comprising:
a support piece;
a gripping device attached to the support piece, adapted to be inserted into an exhaust pipe, the gripping device comprising a
   a resilient elongate flexible body with a gripping surface,
   a flexible pull element extending along or in the flexible body from an end part to the support piece, and
   an actuator mounted on the support piece, wherein
      the flexible pull element is with a distal end connected to an end part of the flexible body and with a proximal end connected to the actuator, wherein upon exertion of a pull force on the pull element by the actuator, the resilient body assumes a curved shaped for bringing the gipping surface into contact with an inside part of an exhaust pipe.

A user may insert the elongate flexible body into an exhaust pipe, e.g. an exhaust pipe having a curve or bend at its distal end, wherein during said insertion the flexible body is not tensioned by the actuator so that it will conform to the shape on the exhaust pipe upon insertion and slide along the exhaust pipe wall to its end position. Once the flexible body has been fully inserted into the exhaust pipe, the user may operate the actuator to exert a pulling force on the pull element, causing the flexible body bend into a curved configuration in which at least some of the segments will clamp against the inner surface of the exhaust pipe and in this manner holding the device of the invention in place with respect to the exhaust pipe. The device of the invention may thus conveniently be used with exhaust pipes having different shapes and dimensions.

The gripping device according to the invention combines easy insertion with a firm grip on the exhaust pipe so that during e.g. exhaust emission measurements, the device does not inadvertently become released when the exhaust pipe is moved. This allows a vehicle to which the device is attached to be moved in a vertical direction on a bridge or horizontally when driving on a test bench or on a test range while exhaust gas measurements are carried out with the device according to the invention in its connected state.

An embodiment of a gripping device according to the invention comprises a skirt for fitting around an end part of an exhaust pipe. The skirt forms a funnel for the removal of exhaust gases from the exhaust pipe over a large surface area. The skirt will also in the case of a double exhaust duct cover both ducts and capture all exhaust gases. Furthermore, the skit guides the device into position upon insertion of the flexible body into the exhaust pipe and that closes off the exhaust pipe when the flexible body is in its end position, so that no exhaust gasses can escape when they are collected from the exhaust pipe.

The support piece carrying the flexible body and the skirt may comprise an adjustable stand that is supported on the floor or ceiling of the work space in which the device according to the invention is employed. In a preferred embodiment, the support piece comprises a manual grip and an operating member for controlling the actuator. The device may be manually coupled to an exhaust pipe, for instance for carrying out exhaust gas measurements as part of a periodic maintenance cycle.

The device may comprise a gripper member on an end part of the flexible body having a rigid gripping surface for engaging with an inside of an exhaust pipe.

The outer surface of the elongate flexible body may be smooth, to easily slide along the inner surface of the exhaust pipe, or may along its length be provided with gripping areas of increased friction for engaging with the inner exhaust pipe wall. By providing the end part of the elongate flexible body with a rigid gripping surface, a very strong clamping force with the inside of the exhaust pipe can be achieved.

In a preferred embodiment, the flexible body comprises a plurality of substantially rigid segments connected in series and moveable relative to each other, wherein one of said segments is connected to the support piece, and another of said segments is connected to the pull element;
wherein the plurality of segments is moveable between a substantially straight configuration, in which the segments are substantially aligned along an first axis, and a curved configuration, in which the segments are substantially aligned along a curve,
wherein the pull element comprises a flexible portion extending though the segments;
wherein the is adapted for pulling on the pull element to cause the segments of the gripping device to move relative to each other to the curved configuration in which they form a curved shape for gripping an inner surface of the exhaust pipe and with the flexible portion of the pull element extending in non-linear fashion through the curved shape.
   The array of hingingly connected rigid segments can be rapidly and accurately pushed along a curved trajectory, and can provide a firm gripping force in the operative position.

Preferably, each segment has a maximum outer diameter which is between 0.25 and 0.85 times an inner diameter of the exhaust pipe.

In an embodiment the plurality of segments is adapted for having a substantially predetermined curved shape when in the curved configuration. Thus, when the manoeuvring device is operated to pull on the pull element, the user knows in advance in which direction and/or plane the plurality of segments will curve, and can ensure that the plurality of segments is inserted into an exhaust pipe in such a manner that the curve of segments will at least partially follow a curve of the exhaust pipe. It will be appreciated that the pull element may act on the plurality of segments to assume the predetermined curved shape when movement of the segments is not hindered by the internal surface of the exhaust pipe or the like, i.e. when relative movement of the segments is not hindered by structures external to the device, such as a wall of the exhaust pipe. In case the plurality of segments has been inserted into an exhaust pipe, upon actuation of the manoeuvring device the plurality of segments will generally tend initially towards the predetermined curved shape until one or more of the segments comes into contact with the inner surface of the exhaust pipe. In this case, when segments of the plurality of segments clamp against the inner surface, the shape of the plurality of segments will likely differ somewhat from the predetermined curved shape.

In an embodiment the plurality of segments is adapted for moving relative to each other from the substantially straight configuration to curved configuration within a predetermined plane. For instance, a center line of each segment which coincides with a centrer axis segment and extends between two opposing distal ends of the segment, may intersect and/or remain within said predetermined plane when the segments are moved from the straight configuration to the curved configuration.

In an embodiment the gripping device is rotatable relative to the manoeuvring device around an axis parallel to said first axis. Thus, a user may rotate the gripping device, and thus the plurality of segments, relative to the manoeuvring device, prior to or during insertion of the plurality of segments into the exhaust pipe.

In an embodiment the device comprises a biasing element, such as a compression spring or a beam comprising or made from an elastic material, which extends on an inner side of one or more of the segments and is adapted for biasing the plurality of segments towards the straight configuration. The biasing element urges the plurality of segments towards the straight configuration when no pull force is exerted by the pull element onto the another of the segments. Preferably, when the plurality of segments comprises a number N of segments, the biasing element extends through at least N-2 or N-1 or of these segments, and preferably the biasing element extends at least partially through all of the segments.

In an embodiment the pull element further comprises a substantially rigid rod connected to the flexible portion, said rod extending into the manoeuvring device, wherein the manoeuvring device is adapted for acting on the rod to tension the flexible portion for moving the plurality of segments towards the curved configuration. The manoeuvring device may thus contact the rigid rod, which is typically made from a metal such as hardened steel, and act thereon to tension the flexible portion. A suitable manoeuvring device for acting on a rod is known for instance from US 2011/0101672 A1, which is hereby incorporated by reference in its entirety. As the manoeuvring device contacts the rod rather than the flexible portion of the pull element, relatively large pull forces, such as greater than 1000 N can be exerted on the pull element, without the pull element slipping out of the manoeuvring device.

In an embodiment the manoeuvring device comprises engagement plates for engaging the pull element and translating the pull element relative to the manoeuvring device, wherein each of the plates has a material hardness which is greater than a material hardness of the substantially rigid rod. In this manner the rod will be the part that wears during use, while the engagement plates of the manoeuvring device wear to a significantly smaller degree.

In an embodiment the rod is connected to the flexible portion via a releasable connection, such as a screw connection. The rod may thus easily be replaced, e.g. when worn.

In an embodiment the device comprises a locking mechanism for releasably locking the gripping device with respect to the manoeuvring device in such a manner that translation of said one of the segments relative to the manoeuvring device is substantially blocked. The gripping device in its entirety may thus easily be replaced by unlocking the locking device, removing the gripping device and arranging a replacement gripping device such that its pull element is engaged by the manoeuvring device, and locking the one of said segments of the replacement gripping device with respect to the manoeuvring device. Preferably the locking mechanism allows rotation of the gripping device relative to the manoeuvring device around an axis parallel to the first axis.

In an embodiment the hand piece comprises an outlet opening and a valve arranged in said outlet opening in such a manner that the valve is moveable between an open position, in which the valve substantially allows passage of exhaust gas through said opening, and a closed position in which the valve substantially blocks passage of exhaust gas through said opening. Generally, during use, a vacuum duct or the like for drawing off exhaust gases that pass through the device is connected to the outlet opening. By closing the valve when the device of the invention is not connected to an exhaust pipe, power usage by the vacuum system which does not aid in drawing off exhaust gases can be reduced.

Preferably, the valve is provided with an abutment surface arranged for contacting the rod, such that the rod pushes the valve to the open position when the pull element causes the plurality of segments to form a curved shape for gripping the inner surface of the exhaust pipe. In this manner the valve is automatically opened when the segments grip the exhaust pipe's inner surface. The valve may further be provided with a biasing element, such as a spring, to bias the valve to the closed position, in which case the valve is automatically closed when the segments are in the substantially straight configuration.

In an embodiment the device further comprises a skirt connected to the hand piece and adapted to be partially arranged around the exhaust pipe. The skirt can partially or completely surround an outer surface of the exhaust pipe while the gripping device holds the device of the invention in place with respect to the exhaust pipe.

Preferably, the skirt is connected to the hand piece in such a manner that the skirt is rotatable relative to the manoeuvring device, and/or such a manner that the skirt is translatable relative to the manoeuvring device along the first axis. This allows the position of the skirt to be adjusted somewhat relative to the open end of the exhaust. For instance, the skirt may be translatable along the first axis over a distance of at least 5 cm, e.g. a distance of between 6 and 10 cm, and/or the skirt may be rotatable relative to the first axis over a range of between +10 to −10 degrees.

In an embodiment in the plurality of segments each segment other than said one segment and the other segment is connected at most to two of its directly neighbouring segments. This allows the segments to easily curve.

In an embodiment, the plurality of number of segments comprises two or more segments connected in series, wherein preferably the plurality of segments comprises at least four segments connected in series, e.g. between 6 and 12 segments connected in series.

In an embodiment the plurality of segments is adapted for contacting an inner surface of the exhaust pipe at least three different points which are spaced apart from each other along a longitudinal direction of the gripping device. This ensures a solid grip on the exhaust pipe. For instance, one of the segments may contact the inner surface of the exhaust pipe at a first point, and two other segments may contact the inner surface of the exhaust pipe at two other points.

In an embodiment said one segment has a length that is at least 3 times the length of its directly neighbouring segment. The first segment may thus be used to contact an inner surface of the pipe at a first position while one or more of the other segments contact the pipe at two other positions, so that the inner surface of the pipe can be gripped by the segments at least three points.

In an embodiment wherein a first segment of the plurality of segments comprises a protrusion adapted to be accommodated in an open ended slot of a second directly neighbouring segment of the plurality of segments, the first segment further comprising edges adapted for contacting edges of the first segment when the plurality of segments is in the curved configuration, wherein the edges of the first and second segment are adapted to be completely spaced apart from each other when the plurality of segments is in the substantially straight configuration. Preferably, the protrusion and open ended slot are adapted for preventing movement of the protrusion out of the open ended slot while allowing rotation of the first segment relative to the second segment in such a manner that the central axes of the first and second segment do not coincide when the plurality of segments is in the curved configuration. For instance, both the protrusion and the slot may comprise a narrow portion and a broader portion, with the narrow portion closer to the end of the segment that is proximate to the manoeuvring device.

### SHORT DESCRIPTION OF DRAWINGS

The present invention will be discussed in more detail below, with reference to the attached drawings, in which

FIG. 1A shows an isometric view of a device according to the present invention, with the segments of the internal gripping device thereof in a straight configuration;

FIG. 1B shows a longitudinal cross-sectional view of the device of FIG. 1A

FIG. 2A shows a detail of a part of the device of FIG. 1A, when the plurality of segments is in the straight configuration;

FIG. 2B shows a detail of a part of the device of FIG. 1A, when the plurality of segments is in the curved configuration;

FIG. 3 illustrates how the gripping device can be releasably locked in place with respect to the manoeuvring device of the device of the present invention;

FIGS. 4A and 4B shows details of individual segments of the plurality of segments; and

FIG. 5 shows an embodiment of a gripping device according to the invention, with a gripper member on an end part of the elongate flexible body.

### DESCRIPTION OF EMBODIMENTS

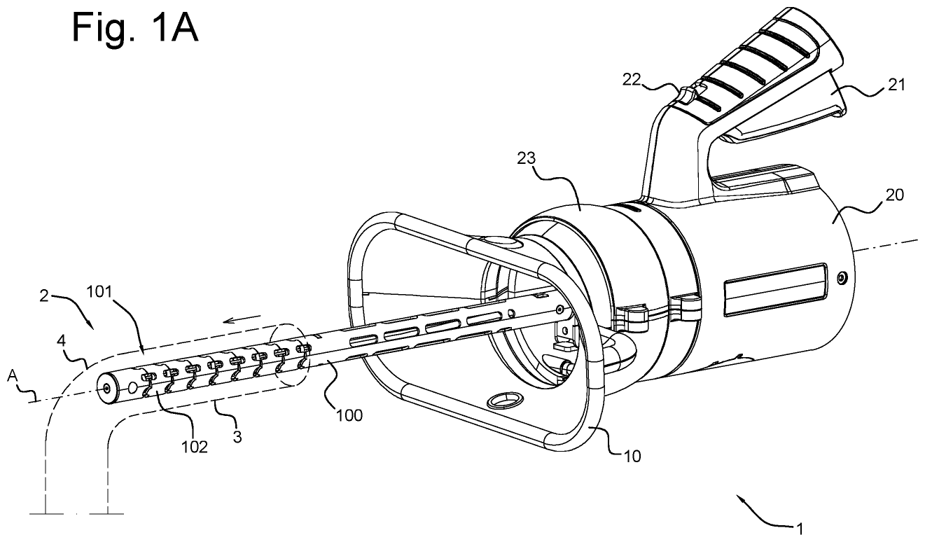

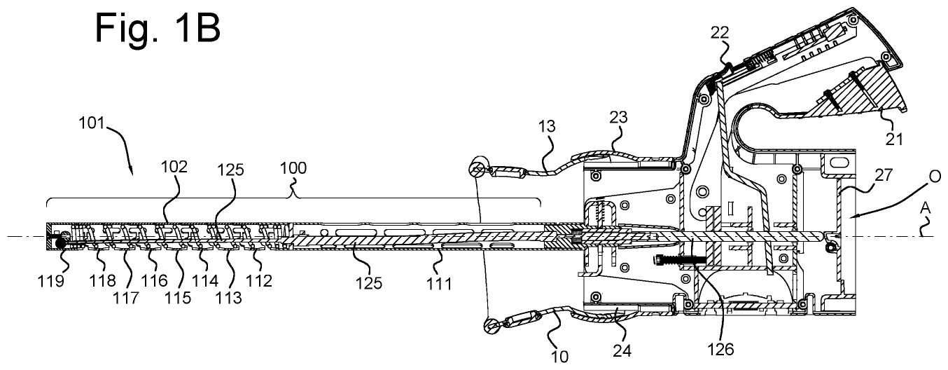

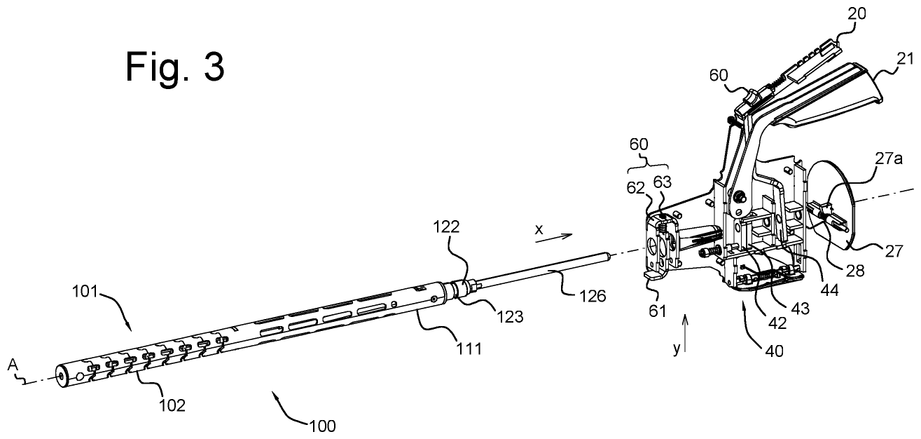

FIGS. 1A and 1B respectively show an isometric view of a device 1 according to the invention as it is being inserted into a an exhaust pipe 2 of a vehicle (not shown), and a longitudinal cross-section of the device of FIG. 1A. The exhaust pipe 2, which is shown in FIG. 1A to be transparent for reasons of clarity, has substantially straight portion 3 which merges into a curved portion 4 that is connected to further exhaust ducts of the vehicle. The device 1 comprises a gripping device 100 with a flexible body 101 having a gripping surface 102 that is to be inserted into the exhaust pipe 2, a skirt 10 which is to partially surround the exhaust pipe, and a hand piece 20. The hand piece 20 is provided with a manually operable trigger 21 for actuating the gripping device 100 to pull on a pull element comprising a flexible wire 125 that is connected to a rigid metal rod 126, shown in FIG. 1B, to cause segments 111-119 of the flexible body 101 to assume a curved configuration and to engage the gripping surface 102 with an inside wall of the exhaust pipe 2. A release button 22 is provided for releasing the pull-force exerted on the pull element, to allow the plurality of segments 111-119 device to move back into a substantially straight configuration shown in FIGS. 1A and 1B, in which the segments 111-119 of the gripping device are aligned along a first straight axis A. The first segment 111 of the segments 111-119 is releasably attached to the hand piece as will be shown in more detail with reference to FIG. 3. This first segment 111 is considerably longer (e.g. at least 3 times longer) than its directly neighboring segment 112, and is also considerably longer than segments 113-118 which are shaped identically to segment 112. In the embodiment show, the length of segment 111 is equal to or greater than a combined length of the other segments 112-119 of the plurality of segments when the plurality of segments is in the substantially straight configuration. During use, the first segment will generally contact an inner surface of the exhaust pipe when the segments are in a curved configuration, and one or two of the other segments will contact the inner surface of the exhaust pipe as well, in this manner providing at least three points of contact between the gripping device and the inner surface of the exhaust pipe.

The skirt 10 has a hemispherical surface 13 which is accommodated in a matching surface 23 of the hand piece 20, so that the skirt can rotate relative to the hand piece 20 over a range of +10 degrees from the first axis A to −10 degrees from the first axis A. The surface 23 of the hand piece 23 in turn is translatable over a distance of 7 cm with respect to an inner portion 24 of the hand piece 20, along the first axis A. When the gripping device 100 is clamped against an inner surface of an exhaust pipe, the orientation and position of the skirt 10 relative to the gripping device 100 can thus be adjusted to a more optimal position with respect to the exhaust pipe.

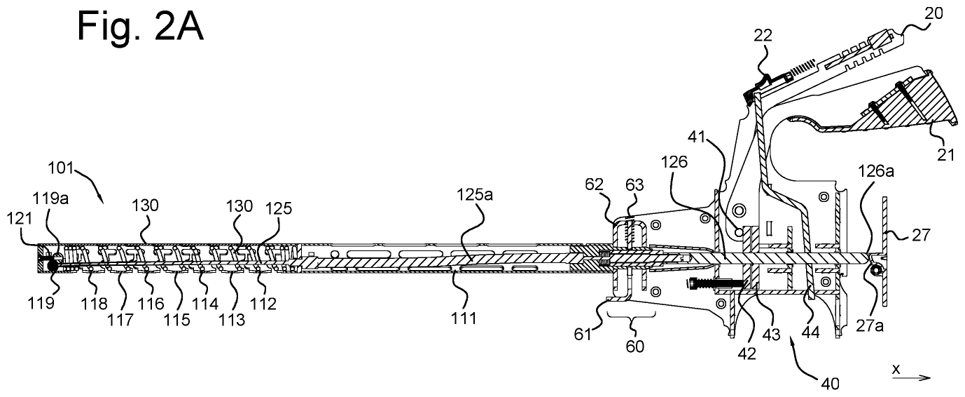

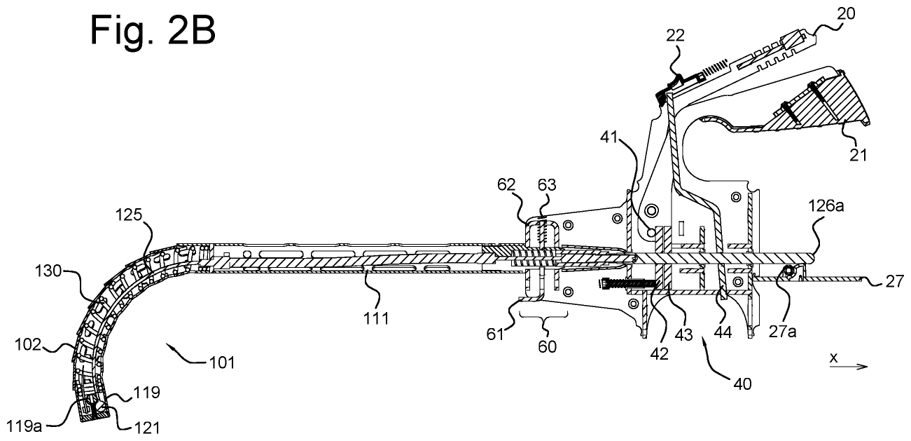

During use, exhaust gases can pass from the skirt 10, through the hand piece 20, to an outlet opening O of the hand piece 20, which outlet opening is adapted for connection to an duct, such as a flexible duct, that may be connected to a vacuum system or low pressure system for suctioning off the exhaust gases. A valve 27 is rotatably arranged in the outlet opening O, such that the valve can be rotated from the closes position shown in FIG. 1B, to an open position, as shown in FIG. 2B. Openings and slots provided in the circumferential walls of the segments further ensure that when the segments clamp against the inner surface of an exhaust pipe, gases can still flow through the skirt 10 and hand piece 20 to the outlet opening O.

FIGS. 2A and 2B show cross-sectional details respectively of part of the device of FIG. 1A when the plurality of segments is in the straight configuration, and when the plurality of segments are in the curved configuration. For reasons of clarity, the skirt 10 and some elements of the hand piece 20, such surface 23 and inner portion 24, have been omitted in FIGS. 2A and 2B.

In FIG. 2A, a biasing element in the form of a compression spring 130 is provided which is attached to the first segment 111 and to the last segment 119 in of the plurality of segments 111-119 that are connected in series. The spring 130 extends on an inner side of the segments 111-119 and biases the segments into the substantially straight configuration in which the segments are aligned along the first axis A. When the segments are in the straight configuration, a distal end 126a of the rod 126 may lie against, or be spaced apart from an abutment surface 27a of the valve 27, and the valve 27 is biased, by means of a spring 28 shown in FIG. 3, to the position shown in FIG. 2A in which it substantially closes off the opening O of the hand piece 20.

Also shown in greater detail in FIGS. 2A and 2B an element 121 that is provided at a distal end of the flexible portion 125 of the pull element and which lies against an inner surface of segment 119 and an internal pin 119a of segment 119 in such a manner that the element cannot be pulled in direction X beyond the pin 119a. Thus, when a pull force is exerted on the flexible portion in direction X, this will cause the spring 130 and the plurality of segments 111-119 to bend.

The hand piece 20 is provided with a maneuvering device 40 through which the metal rod 126 of the pull element extends. The maneuvering device 40 comprises a lever 41 which is fixed to the manually operable trigger 21 and is arranged for pushing a first engagement plate 42 and a second engagement plate 43 through which the rod 126 extends, substantially along direction X. The plates 42, 43 then engage the rod, so that the rod 126 too is moved in direction X, and the rod and flexible portion 125 of the pull-element pull the plurality of segments 111-119 towards the curved configuration shown in FIG. 2B.

A locking plate 44 also engages the rod 126 and prevents the rod from moving in a direction opposite to direction X as long as the release button 22 is in the locked position shown. By sliding the release button 22 towards an unlocked position, also substantially in direction X, the plate 44 is disengaged from the rod 126, allowing the rod to slide back in a direction opposite to X due to the spring force exerted by the compression spring, until the plurality of segments are again in the substantially straight configuration.

FIG. 3 illustrates how the gripping device 100 can be releasably locked in place with respect to the manoeuvring device 40. At an end of the first segment 111 the gripping device is provided with a bushing 122 which has a first outer diameter and which comprises a circumferential groove 123 having a smaller second outer diameter. The first outer diameter corresponds substantially to diameters of openings in U-shaped plate 62 of locking mechanism 60, so that the bushing can be substantially supported in these openings. The U-shaped plate 62 is fixed with respect to the manoeuvring device 40. The locking mechanism 60 further comprises a plate 61 which comprises an oval opening and which is biased by a spring 63 such that the centre of the oval opening is misaligned with respect to the centres of the openings in the U-shaped plate 62. In order to be able to fix the gripping device 100 to the manoeuvring device 40, first the locking mechanism 60 should be unlocked by manually pushing plate 61 in direction Y until the oval opening and the openings in the U-shaped plate are aligned to allow the bushing 122 to be arranged within the openings of the U-shaped plate 62. Once the gripping device has then been inserted along direction X into the manoeuvring device and the plate 61 is released, the spring 63 will push the plate 61 such that the inner edge of its opening partially falls into the groove 123, in this manner blocking translation of the gripping device 100 relative to the manoeuvring device along the direction X, while still allowing rotation of the gripping device relative to the manoeuvring device around axis A.

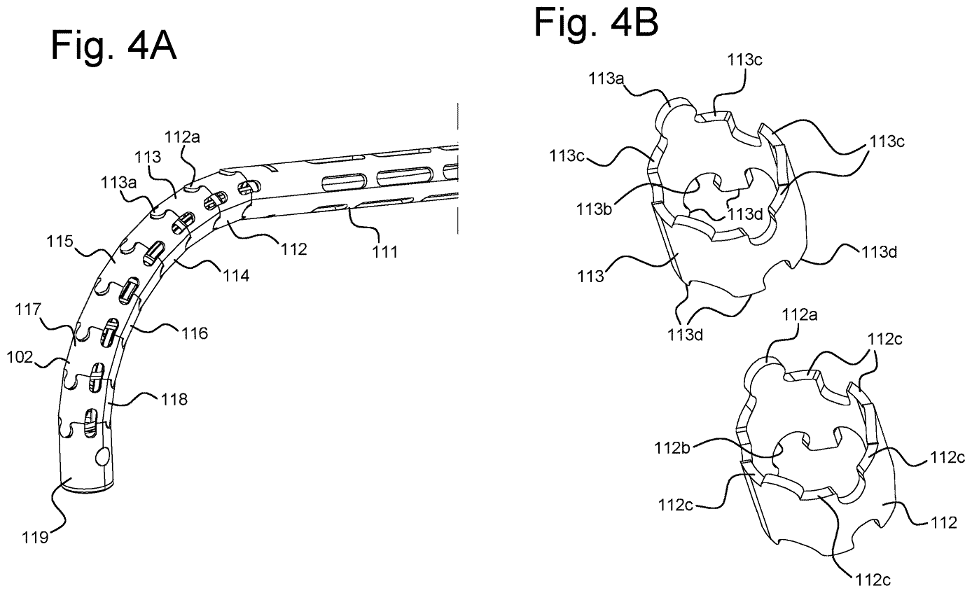

FIG. 4A shows a detail of the segments of the plurality of segments in the curved configuration, with the center lines of each segment lying in a common plane.

FIG. 4B shows an isometric view of two of these segments 112,113, which are identically shaped. Segment 112, 113 each comprise a protruding part 112a, 113a which forms a distal end of the segment along the longitudinal axis thereof. The protruding part 112a is adapted to fit in opening 113b, as shown in FIG. 4A, and allow segment 113 to move relative to segment 112 between a position in which one or more of distal edges 113d abuttingly contact edges 113c and in which the center lines of the segments 112,113 do not coincide, and a position in which the center lines of segments 112,113 substantially coincide and the distal edges 113d are spaced apart from the edges 113c of segment 112.

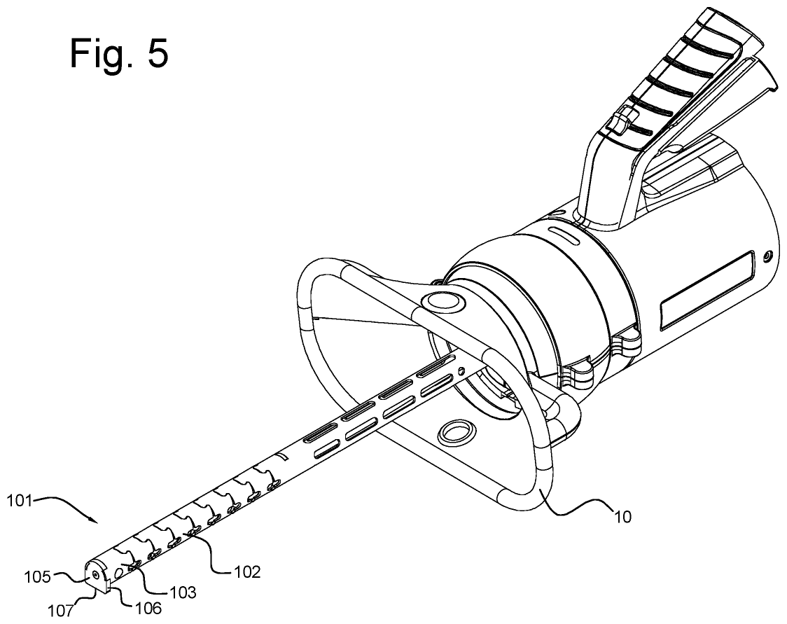

FIG. 5 shows an embodiment of a gripping device in which the flexible body 101 is provided at its end part 103 with a gripping member 105. The gripping member 105 has sides 106,107 that project beyond the perimeter of the end part 103 for firmly engaging with the inner wall of the exhaust pipe.

The present invention has been described above with reference to a number of exemplary embodiments as shown in the drawings. Modifications and alternative implementations of some parts or elements are possible, and are included in the scope of protection as defined in the appended claims.

1-15. (canceled)

16. A device for internal gripping of a vehicle exhaust pipe for drawing off exhaust fumes from a vehicle, comprising:
a support piece which allows exhaust gas to pass therethrough from an inlet side to an outlet opening;
an actuator mounted on the support piece;
a gripping device attached to the support piece and adapted to be inserted into the exhaust pipe, the gripping device comprising an elongate flexible body with a gripping surface; and
a flexible pull element extending along or within the flexible body from an end part to the support piece, a distal end of the flexible pull element being connected to the end part of the flexible body and a proximal end of the flexible pull element being connected to the actuator, such that upon exertion of a pull force on the flexible pull element by the actuator, the flexible body is adapted to assume a curved shape for bringing the gripping surface into engaging contact with an inner surface of the exhaust pipe.

17. The device according to claim 16, wherein the flexible body comprises a plurality of substantially rigid segments connected in series and moveable relative to each other, wherein a first segment is connected to the support piece, and a final segment is connected to the pull element and the plurality of segments is moveable between a substantially straight configuration, in which the segments are substantially aligned along an axis and a curved configuration, in which the segments are substantially aligned along a curve.

18. The device according to claim 17, wherein the pull element comprises a flexible portion extending though the segments and the actuator is adapted for pulling on the pull element to cause the segments to move relative to each other to the curved configuration in which they form a curved shape for gripping the inner surface of the exhaust pipe and with the flexible portion of the pull element extending in non-linear fashion through the curved shape.

19. The device according to claim 17, wherein the plurality of segments is adapted for having a substantially predetermined curved shape when in the curved configuration.

20. The device according to claim 17, wherein a biasing element extends on an inner side of one or more of the segments and is adapted for biasing the plurality of segments towards the straight configuration.

21. The device according to claim 16, wherein the flexible pull element is attached via a substantially rigid rod to the actuating device, the rod being connected to the flexible pull element via a releasable connection.

22. The device according to claim 21, wherein the actuator comprises engagement plates for engaging the rigid rod and translating the rigid rod relative to the actuator, wherein each of the plates has a material hardness which is greater than a material hardness of the rigid rod.

23. The device according to claim 16, further comprising a locking mechanism for releasably locking the gripping device with the flexible body in its curved shape.

24. The device according to claim 17, wherein each segment other than said first segment and said final segment is connected at most to two directly neighboring segments.

25. The device according to claim 17, wherein said first segment has a length that is at least 3 times the length of a directly neighboring segment.

26. The device according to claim 17, wherein said first segment comprises a protrusion adapted to be accommodated in an open ended slot of a directly neighboring second segment, the first segment further comprising edges adapted for contacting edges of the second segment when the plurality of segments is in the curved configuration, wherein the edges of the first and second segments are adapted to be spaced apart from each other when the plurality of segments is in the substantially straight configuration.

27. The device according to claim 16, wherein the gripping device is rotatable relative to the actuator around an axis.

28. The device according to claim 16, wherein the support piece comprises a valve arranged in said outlet opening and the valve is moveable between an open position, in which the valve allows passage of exhaust gas through said outlet opening, and a closed position in which the valve blocks passage of exhaust gas through said opening.

29. The device according to claim 28, wherein the valve is movable to the open position when the flexible pull element acts on the flexible body to form a curved shape for gripping the inner surface of the exhaust pipe.

30. The device according to claim 16, wherein the support piece comprises a skirt for fitting around an end part of an exhaust pipe.

31. The device according to claim 30, wherein the skirt is connected to the support piece to be rotatable relative to the actuator or translatable relative to the actuator.

32. The device according to claim 16, wherein the support piece comprises a manual grip and an operating member for controlling the actuator.

33. A method of connecting a vacuum or low pressure system to an exhaust pipe of a vehicle for suctioning off the exhaust gases produced by said vehicle, using a device for internal gripping of an internal surface of the exhaust pipe, the method comprising:
inserting into the exhaust pipe an elongate body having a proximal end and a distal end with a gripping surface; and
actuating a flexible pull element extending along or within the flexible body from the proximal end to the distal end to cause the flexible body to assume a curved shape thereby bringing the gripping surface into engaging contact with the internal surface of the exhaust pipe.

34. The method of claim 33, wherein the device for internal gripping of an internal surface of the exhaust pipe comprises a hollow support piece which allows exhaust gas to pass therethrough from an inlet side to an outlet opening and having a skirt, adjustably connected to the support piece, whereby the method comprises adjusting the skirt to fit around an end part of an exhaust pipe.

35. A device for internal gripping of an exhaust pipe, comprising:
a support piece; and
a gripping device attached to the support piece, adapted to be inserted into the exhaust pipe, the gripping device comprising a:
a elongate flexible body with a gripping surface,
a pull element extending along or in the flexible body from an end part to the support piece, and
an actuator mounted on the support piece,
wherein a distal end of the pull element is connected to an end part of the elongate flexible body and a proximal end of the pull element is connected to the actuator, whereby the flexible body is adapted to assume a curved shape for bringing the gripping surface into contact with an inside part of an exhaust pipe upon exertion of a pull force on the pull element by the actuator and in that the flexible body comprises a plurality of substantially rigid segments connected in series and moveable relative to each other, wherein a first segment is connected to the support piece and a final segment is connected to the pull element and the plurality of segments is moveable between a substantially straight configuration in which the segments are substantially aligned along an axis and a curved configuration, in which the segments are substantially aligned along a curve for gripping an inner surface of the exhaust pipe.
